(19) United States
(12) Patent Application Publication
(10) Pub. No.: US 2008/0101705 A1
(43) Pub. Date: May 1, 2008

(54) SYSTEM FOR PATTERN RECOGNITION WITH Q-METRICS

(75) Inventors: Magdi A. Mohamed, Schaumburg, IL (US); Weimin Xiao, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/554,643

(22) Filed: Oct. 31, 2006

(51) Int. Cl. G06K 9/62

(52) U.S. Cl. 382/224; 382/159

(57) ABSTRACT

A pattern recognition system (100, 900, 1202, 1300) includes a configurable distance metric evaluator (112, 600, 1204). The configurable distance metric evaluator (112, 600, 1204) is adaptable, via a configuration parameter to better match distributions of feature vectors within classifications and clusters and moreover to better match boundaries between feature vector subspaces associated with different classifications or clusters, and therefore provides for reduced pattern recognition errors.

### FIELD OF THE INVENTION

The present invention relates generally to pattern recognition.

### BACKGROUND

There are numerous types of practical pattern recognition systems including, by way of example, facial recognition, and fingerprint recognition systems which are useful for security, speech recognition and handwriting recognition systems which provide alternatives to keyboard based human-machine interfacing, radar target recognition systems and vector quantization systems which are useful for digital compression and digital communications.

Generally, pattern recognition works by using sensors to collect data (e.g., image, audio) and using an application specific feature vector extraction process to produce one or more feature vectors that characterize the collected data. The nature of the feature extraction process varies depending on the nature of the data. Once the feature vectors have been extracted, a particular pattern matching algorithm such as, for example, a k-Nearest Neighbor algorithm, a Nearest Prototype algorithm, a Support Vector Machine algorithm, or an Artificial Neural Network algorithm is used to determine a vector subspace in which the extracted feature vector belongs. Each vector subspace corresponds to one possible identity of what was measured using sensors. For example in facial recognition, each vector subspace can correspond to a particular person. In handwriting recognition each vector subspace can correspond to a particular letter or writing stroke and in speech recognition each subspace can correspond to a particular phoneme-an atom of human speech.

Generally, pattern recognition systems use a metric in defining the vector subspaces associated with the different identities. The most common metric is, perhaps, the Euclidean distance metric. The Euclidean distance metric defines planar (or hyperplanar) boundaries between vector subspaces (also known as the decision surfaces). In practical applications in which there are non-planar boundaries between vector subspaces of different classifications the use of the Euclidean norm can lead to recognition errors. For example, in the case of facial recognition systems, errors are either false positives or missed recognitions.

Thus, it would desirable to be able to fine decision surfaces in order to better control recognition errors.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a pattern recognition system;

FIG. 2 is a graph showing unity level contour plots for a configurable distance metric, for three values of a configuration parameter;

FIGS. 3-4 are 3-space graphs each showing two surfaces which are at a predetermined Q-metric distance from two feature vectors, and a third surface which is a locus of points at equal Q-metric distances from the two feature vectors;

FIG. 5 is a high level flowchart of a computer program for performing pattern recognition using a Q-metric;

FIG. 6 is a block diagram of a Q-metric computation engine;

FIG. 7 is a flowchart of a computer program for performing unsupervised learning;

FIG. 8 is a flowchart of Q-metric nearest prototyype classification;

FIG. 9 is a schematic representation of an Q-metric based ANN according to an embodiment of the invention;

FIG. 10 is a flowchart of a program for training a Q-metric based ANN pattern recognition program;

FIG. 11 is a flowchart of a program for training a nearest prototype pattern recognition system;

FIG. 12 is a block diagram of a system for training pattern recognition systems that use Q-metric distance functions; and

FIG. 13 is a block diagram of a computer that can be used to run pattern recognition programs.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to machine learning. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of machine learning described herein. The non-processor circuits may include, but are not limited to, a radio receiver, a radio transmitter, signal drivers, clock circuits, power source circuits, and user input devices. As such, these functions may be interpreted as steps of a method to perform machine learning. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

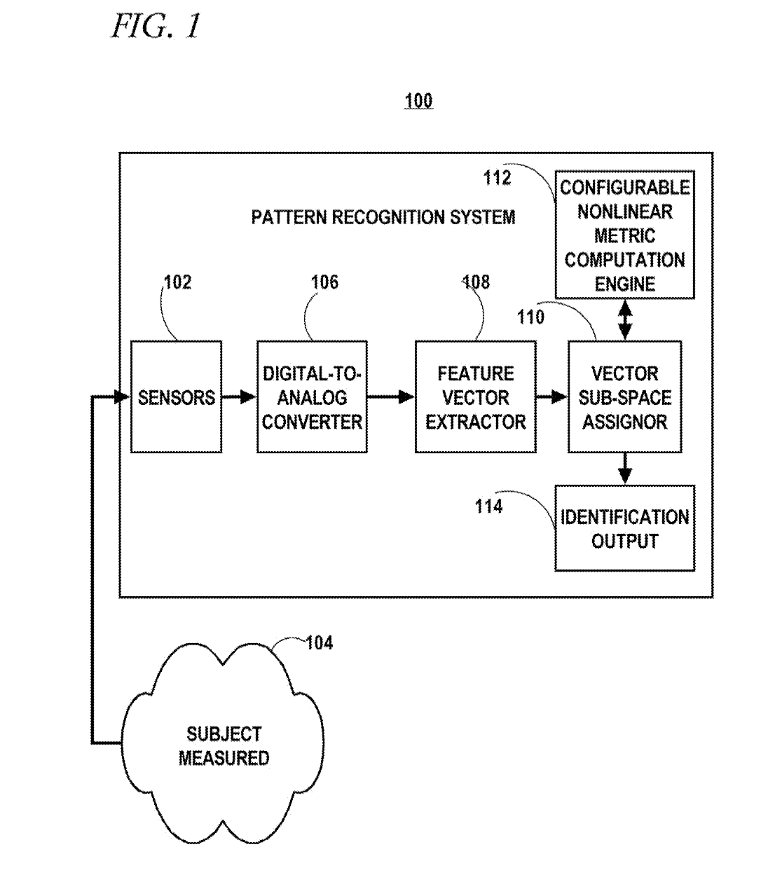

FIG. 1 is a block diagram of a pattern recognition system 100. The pattern recognition system 100 has one or more sensors 102 that are used to collect measurements from subjects to be recognized 104. By way of example, subjects 104 can be living organisms such as persons, spoken words, handwritten words, animate or inanimate objects. The sensors 102 can take different forms depending on the subject. By way of example, various types of fingerprint sensors can be used to sense finger prints, microphones can be used to sense spoken words, cameras can be used to image faces, and radar can be used to sense airplanes and other objects.

The sensors 102 are coupled to one or more digital-to-analog converters (D/A) 106. The D/A 106 is used to digitize the data collected by the sensors 102. Multiple D/A's 106 or multi-channel D/A's 106 may be used if multiple sensors 102 are used. By way of example, the output of the D/A 106 can take the form of time series data and images. The D/A 106 is coupled to a feature vector extractor 108. The feature vector extractor 108 performs lossy compression on the digitized data output by the D/A 106 to produce a feature vector which compactly represents information derived from the subject 104. Various feature vector extraction programs that are specific to particular types of subjects are known to persons having ordinary skill in the relevant art.

The feature vector extractor 108 is coupled a vector sub-space assignor 110. Assigning a feature vector to a sub-space completes a task of classifying the subject. The vector sub-space assignor 110 is coupled to a configurable non-linear metric computation engine 112. The computation engine 112 is used to make nonlinear metric distance measurements required by the vector-subspace assignor 110. The vector sub-space assignor 110 can use a variety of techniques to assign a feature vector to a vector subspace. These include, by way of nonlimitive example, nearest prototype classification, k-nearest neighbor classification, linear discriminant analysis, radial basis functions, kernel-based classification, support vector machines, feed-forward artificial neural networks, decision trees, hidden Markov models, etc. In making sub-space assignments the vector sub-space assignor 110 relies on vector distances determined by the configurable nonlinear metric computation engine 112. The configurable nonlinear metric computation engine may be implemented in software, hardware or a combination of hardware and software.

An identification output 114 is coupled to the vector sub-space assignor 110. Information identifying a particular vector-subspace (which corresponds to a particular class or individual) is output via the output 114. The identification output 114 can, for example, comprise a computer monitor.

According to certain embodiments the configurable nonlinear metric computation engine implements a fuzzy set function of coordinate differences termed a ‘Q-metric’. The Q-metric can be represented by the following equation:

$${d}_{λ} ( x , y ) = \{ \begin{matrix}\frac{{\prod }_{i = 1}^{n} ( 1 + λ \vert {x}_{i} - {y}_{i} \vert ) - 1}{λ} & λ ∈ [ - 1 , 0 ) \\ {\sum }_{i = 1}^{n} \vert {x}_{i} - {y}_{i} \vert & λ = 0\end{matrix} \qquad EQU . 1$$

where, λ ∈ [−1,0] is a configuration parameter;

xᵢ ∈ [0,1] is an i^{th} component of a first n-dimensional feature vector denoted x

yᵢ ∈ [0,1] is an i^{th} component of a second n-dimensional feature vector denoted y;

d_{λ}(x,y) ∈ [0,n] is a distance between the first feature vector and the second feature vector, computed by the Q-metric.

The configuration parameter λ alters the characteristics of the Q-metric function, thereby allowing the Q-metric to be adaptable to the distribution of members of a particular class or cluster in the feature vector space, and hence reducing pattern recognition errors. For the Q-metric function defined by equation 1 the configuration parameter A varies between the real values −1.0 and 0.0. Alternatively, the configuration parameter is restricted to the range [−1,0), in which case only the first expression in equation one is needed to describe the nonlinear metric computation engine 112.

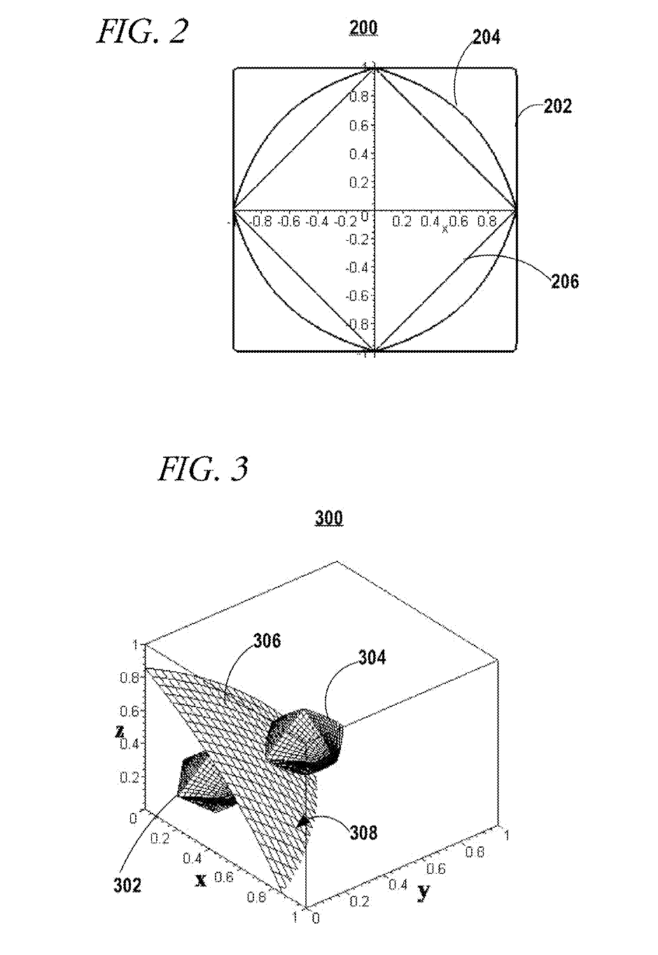

FIG. 2 is a graph 200 showing unity level contour plots 202, 204, 206 for the Q-metric, for three values of the configuration parameter λ. Each of the contour plots shows a locus of Cartesian coordinates for which the Q-metric distance from the origin is equal to one. The outer square shaped plot 202 is for the case that the configuration parameter λ is equal to −1.0. The inner diamond shaped plot 206 is for the case that the configuration parameter λ is equal to zero. The intermediate, approximately circular shaped plot 204 is for the case that the configuration parameter λ is equal to −0.7. By varying the configuration parameter other shapes between the square shaped output plot 202 and the inner diamond shaped plot 206 are obtained. Thus, by using the Q-metric a system that is more agile in terms of adapting to the distribution of features vectors within a classification is obtained.

FIG. 3 is a 3-space graph 300 showing two surfaces 302, 304 which are at predetermined Q-metric distances from two feature vectors, and a third surface 306 which is a locus of points at equal Q-metric distances from the two feature vectors. A first surface 302 is a first locus of points at Q-metric distance of 0.2 from a first feature vector (0.2, 0.2, 0.2), with the configuration parameter λ equal to −0.01. The second surface 304 is a second locus of points at Q-metric distance of 0.2 from a second feature vector (0.45, 0.45, 0.45) with A equal to −1.0. The first feature vector represents (e.g., is the mean of) a first subject classification (e.g., particular phoneme, individual's face, particular fingerprint, particular radar target, etc.) and the second feature vector represents a second subject classification. The third surface 306 demarcates a decision boundary between the subject classification that is typified by the first feature vector (0.2, 0.2, 0.2) and the subject classification that is typified by the second feature vector (0.45, 0.45, 0.45). Note that in establishing the decision boundary, the distance from the first feature vector is determined using the configuration parameter value (−0.01) associated with the first locus of points, and the distance from the second feature vector is determined using the configuration parameter value (−1.0) associated with the second locus of points. Note that rather than being planar, as would be the case when using the standard Euclidean norm distance metric, the decision boundary 306 is curved with a convex side 308 facing the second feature vector (0.45, 0.45, 0.45). Note that not all pattern recognition systems that can be improved through the use of a Q-metric computer explicitly determine the decision boundary as doing so may be prohibitively computationally expensive (depending on the application), especially in the case of high dimensionality feature vector spaces. Nonetheless the decision boundary exists, at least, implicitly.

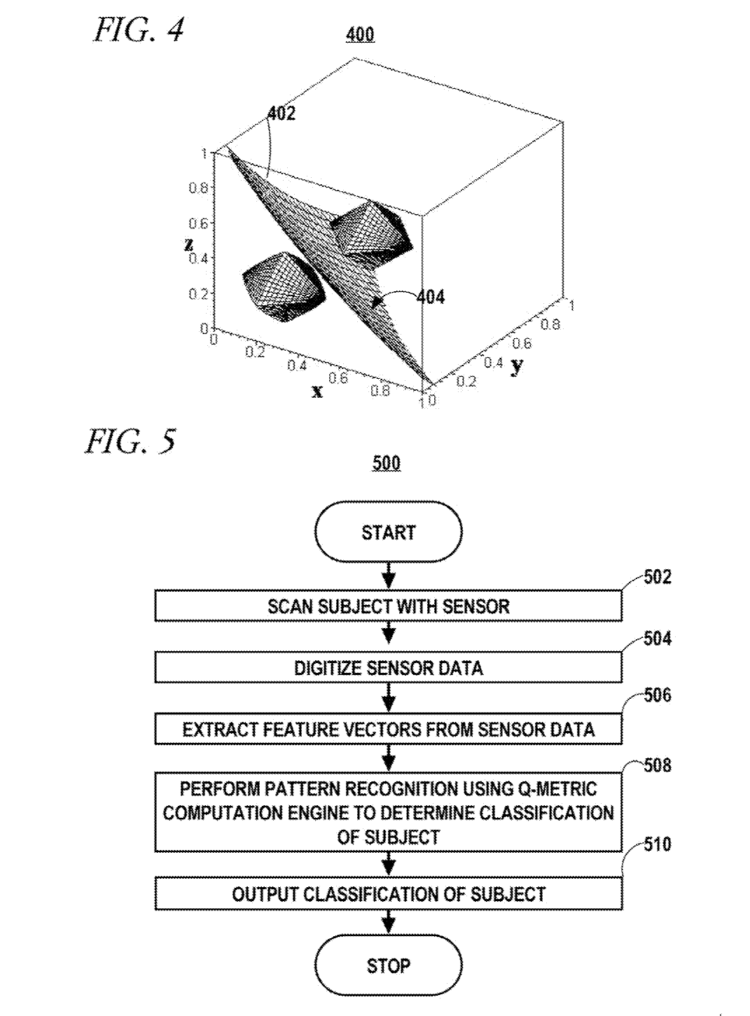

FIG. 4 is another 3-space graph 400 similar to FIG. 3. However, in FIG. 4 the configuration parameter λ values associated with the first and second subject classifications are exchanged. As shown in FIG. 4 a new decision boundary 402 now has a concave side 404 facing the second feature vector. Using different values of the configuration parameter λ for feature vectors representing different subject classifications allows the shape of the decision boundaries between feature vector subspaces to be tuned to better fit the distributions of feature vectors within multiple subject classifications and thereby reduce classification errors.

FIG. 5 is a high level flowchart 500 of a computer program performing pattern recognition using the Q-metric. In block 502 a subject is scanned with a sensor. In block 504 the sensor data is digitized. In block 506 feature vectors are extracted from the digitized sensor data. In block 508 pattern recognition is performed using a Q-metric computation engine in order to determine a classification of the subject. In block 510 the classification of the subject is output (e.g., through a computer monitor).

Aside from coding equation one itself another way to compute values of the Q-metric given by equation one is by the following recursion relation.

ψᵢ=|xᵢ−yᵢ|+ψᵢ₋₁+λ|xᵢ−yᵢ|ψᵢ₋₁, i=1, . . . , n EQU. 2

starting with an initial function value:

ψ₀=0

The Q-metric is then given by:

d_{λ,n}(x,y)=ψₙ

A Q-metric computation engine can be implemented as a programmed processor or specialized hardware. The computational cost of evaluating the Q-metric is relatively low, for example, compared to high order P-metrics.

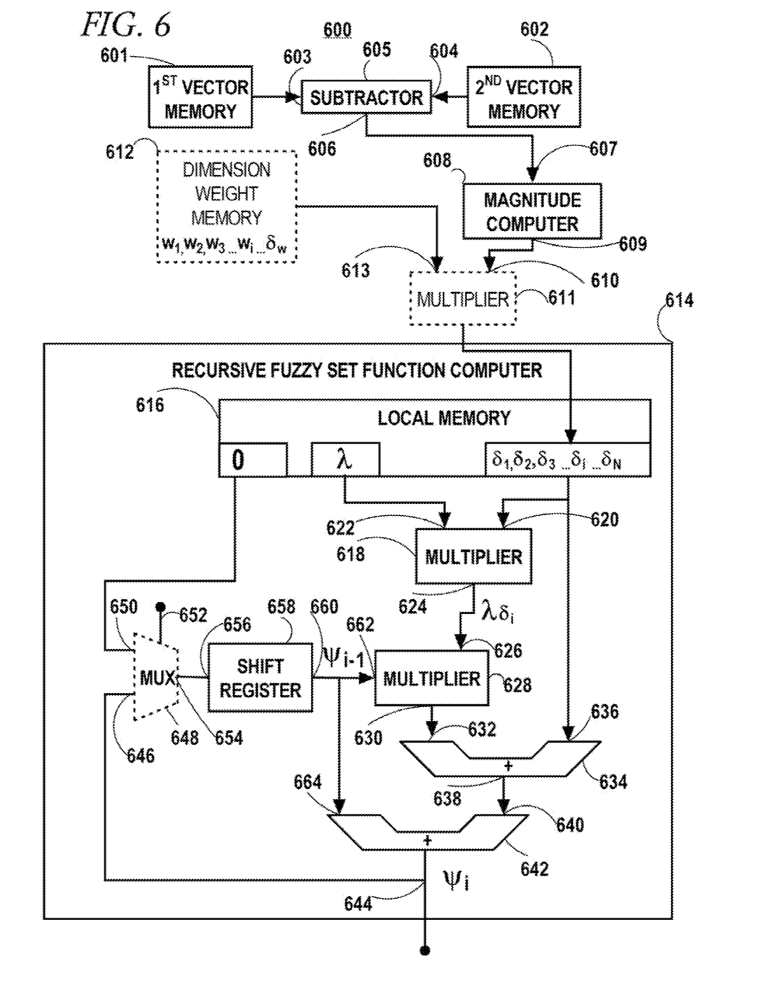

FIG. 6 is a block diagram of one possible hardware implementation of a Q-metric computer 600. A first vector memory 601 and a second vector memory 602 are coupled to a first input 603 and a second input 604 of a subtracter 605. The Q-metric computer 600 computes a Q metric distance between the first vector and the second vector. In some cases one of the vectors is a stored prototype vector for a pattern classification and the other is a feature vector representing a subject classification. In other cases both vectors are prototype vectors or feature vectors representing subjects. An output 606 of the subtracter 605 is coupled to an input 607 of a magnitude computer 608. The subtracter 605 computes a vector difference between the first vector and the second vector. The magnitude computer 608 computes the absolute value of each component of the difference. An output 609 of the magnitude computer 608 is coupled to a first input 610 of an optional first multiplier 611. An optional dimension weight memory 612 is coupled to a second input 613 of the optional first multiplier 611. The multiplier 611 weights (multiplies) each absolute value vector component difference by a weight stored in the dimension weight memory. If dimension weights are used the Q-metric is generalized to:

$${d}_{λ} ( x , y ) = \{ \begin{matrix}\frac{{\prod }_{i = 1}^{n} ( 1 + λ {w}_{i} \vert {x}_{i} - {y}_{i} \vert ) - 1}{λ} & λ ∈ [ - 1 , 0 ) \\ {\sum }_{i = 1}^{n} {w}_{i} \vert {x}_{i} - {y}_{i} \vert & λ = 0\end{matrix} \qquad EQU . 3$$

where

xi, yi are in the unit interval [0,1]; and

wᵢ ∈ [0,1] is a weight for the i^{th} dimension.

The recursion relation for the Q-metric given by equation two is generalized to:

ψᵢ=wᵢ|xᵢ−yᵢ|+ψᵢ₋₁+λwᵢ|xᵢ−yᵢ|ψᵢ₋₁, i=1, . . . , n; ψ₀=0. EQU. 4

Weighting each dimension differently provides an added degree of control that further improves pattern recognition accuracy and reduces noise, at the expense of some increase in processing complexity.

The optionally weighted, absolute values of the vector component differences, denoted δᵢ are stored in a local memory 616 of a fuzzy set function computer 614. The local memory 616 of the recursive fuzzy set function computer 614 also stores the configuration parameter, denoted λ. The configuration parameter λ stored in the local memory 616 can be changed as needed. The local memory 616 is coupled to a second multiplier 618. The δᵢ's are fed sequentially to a first input 620 of the second multiplier 618. The second multiplier 618 receives the configuration parameter λ at a second input 622. The second multiplier 618 outputs a series of products λδᵢ at an output 624. Note that the index i ranges from one up to the dimension of the vectors N.

The output 624 of the second multiplier 618 is coupled to a first input 626 of a third multiplier 628. An output 630 of the third multiplier 628 is coupled to a first input 632 of a first adder 634. A second input 636 of the first adder 634 sequentially receives the δᵢ's directly from the local memory 616. An output 638 of the first adder 634 is coupled to a first input 640 of a second adder 642.

An output 644 of the second adder 642 is coupled to a first input 646 of a multiplexer 648. A second input 650 of the multiplexer 648 is coupled to the local memory 616. An empty fuzzy set function value, denoted ψ₀, is stored in the local memory 616 and received at the second input 650. A control input 652 of the multiplexer 648 determines which of the first input 646 and second input 650 is coupled to an output 654 of the multiplexer 648. Initially the second input 650 at which the initial (empty) fuzzy set function value ψ₀ is received is coupled to the output 654. For subsequent cycles of operation of the recursive fuzzy set function computer 614 the first input 646 of the multiplexer 648 which is coupled to the output 644 of the second adder 642, is coupled to the output of the multiplexer 648 so that the computer 614 operates in a recursive manner.

The output 654 of the multiplexer 648 is coupled to an input 656 of a shift register 658. An output 660 of the shift register 658 is coupled to a second input 662 of the third multiplier 628 and to a second input 664 of the second adder 642.

The recursive fuzzy set function computer 614 can generate the sequence of values given by the recursion relation given in equation two or four.

During each i^{th} cycle of operation, the output of the second multiplier is λδᵢ, the output of the third multiplier 628 is λδᵢψᵢ₋₁ (the third term in equations two and four), the output of the first adder 634 is δᵢ+λδᵢψᵢ₋₁, and the output of the second adder 642 is ψᵢ₋₁+δᵢ+λδᵢψᵢ₋₁.

It is not necessary to use the multiplexer 648, if the shift register 658 is of a type that can have it's output 660 initialized to zero. It will be apparent to persons having ordinary skill in the art that alternative hardware designs for computing Q-metrics are possible.

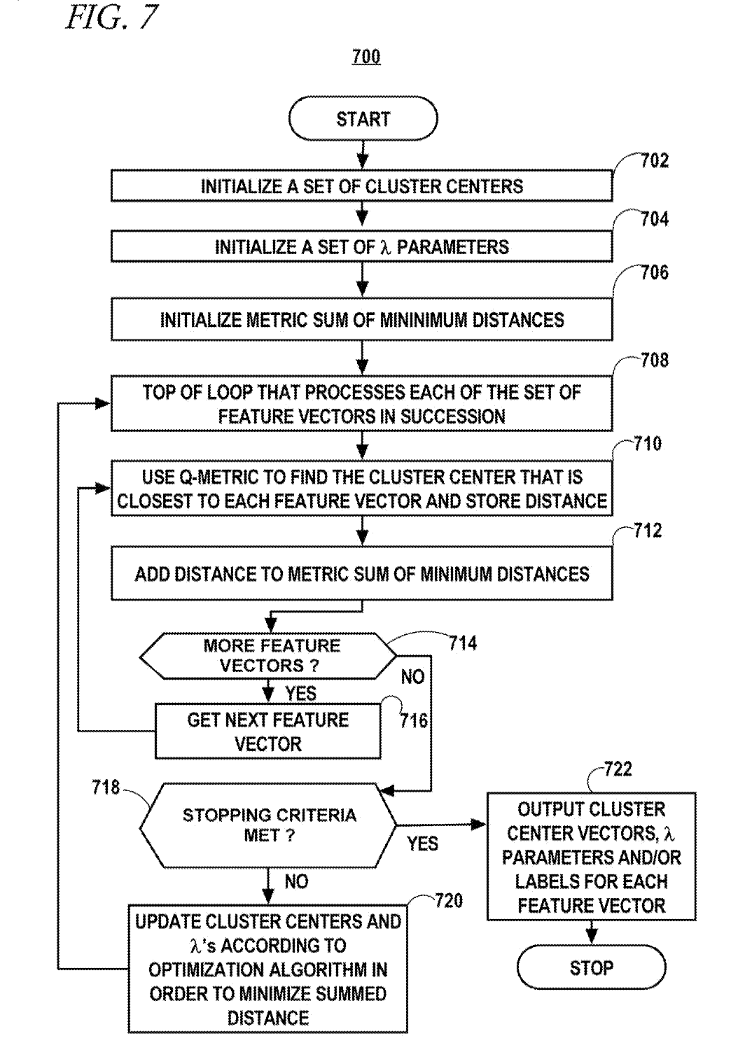

FIG. 7 is a flowchart 700 of a computer program for performing unsupervised learning (clustering). The computer program depicted in FIG. 7 processes a set of feature vectors that includes feature vectors from one or more classifications of subjects (although the identifications of the classifications of subjects are not used as input) and determines two or more mean feature vectors to represent two or more groupings of feature vectors.

In block 702 a number of cluster centers are initialized. The number of cluster centers that are initialized is equal to the number of groupings that are sought. In block 704 a number of configuration parameters are initialized. The cluster centers and the configuration parameters may be initialized to predetermined values or randomly within prescribed intervals (e.g., [0,1] for the cluster centers and [−1,0] for the configuration parameters). One configuration parameter may be initialized for each cluster center. In case a Differential Evolution optimization algorithm is used, multiple sets of cluster centers and configuration parameters will be initialized. In block 706 a sum of the minimum distance from each of a set of training feature vectors to one of the cluster centers is initialized. The sum is over the training feature vectors. The minimum is over the cluster centers. The set of feature vectors may be a large representative sampling of feature vectors constituting what is known as a training data set. Although not shown in FIG. 7, optionally labels for each of the feature vectors may be initialized for example to a null value, e.g., zero, representing no cluster center assignment.

Block 708 is the top of a loop that processes each of the set of feature vectors in succession. In block 710 the Q-metric distance function is used to find the cluster center closest to each successive feature vector and in block 712 the sum that was initialized in block 706 is incremented by the distance to the nearest cluster center. Block 714 test if more feature vectors in the set remain to processed. If so, then in block 716 the next feature vector is read and the program loops back to block 710 in order to process the next feature vector.

When all of the set of feature vectors have been processed, the program branches from block 714 to block 718 which tests if a stopping criteria has been met. The stopping criteria can include an upper limit on a number of iterations of the loop commenced in block 708, or lower limit on a reduction of the summed distance compared to one or more preceding iterations of the loop. Other stopping criteria used in various optimization algorithms are knows to persons having ordinary skill in the art. If the outcome of block 718 is negative, the program branches to block 720 in which an optimization routine is used to update the cluster center coordinates and the configuration parameters for each cluster center in order to minimize the sum of the distances from feature vectors to the closest cluster center. A variety of optimization techniques can be used for optimization, including, for example direct search methods such as the simplex method, simulated annealing or Differential Evolution, or methods that use derivative information such as the conjugate gradient method. After block 720, the program loops back to block 708 and proceeds as previously described. If it is determined in block 718 that the stopping criteria has been met, meaning that the program has converged to a stable set of cluster centers, (or that a maximum number of iterations has been reached) then in block 722 the cluster center vectors, configuration parameters λ and optionally the labels of each feature vector are output. The program will determine the cluster centers and configuration parameters λ. The information output by the program 700 can then be used to perform pattern recognition on feature vectors derived from subjects of unknown identity. A variety of different pattern recognition algorithm can use the information output by the program 700.

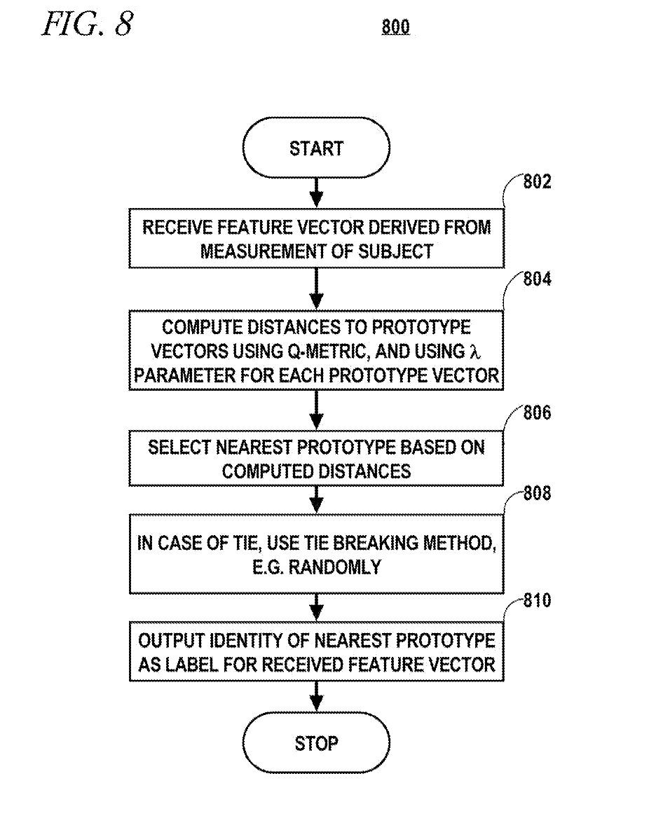

FIG. 8 is a flowchart 800 of Q-metric nearest prototype classification. This is one example of a vector sub-space assignor that may be used in the pattern recognition system 100. In block 802 a feature vector derived from a measured subject is input. In block 804 the Q-metric distances from the feature vector read in block 802 to a set of prototype vectors are computed. In executing block 804 a configuration parameter A associated with each prototype vector represents is utilized. If information derived from the program shown in FIG. 7 is to be used, then the cluster centers can by used as prototype vectors. Prototype vectors generated by the methods or programs different from that shown in FIG. 7 can also be used in executing the program shown in FIG. 8. In block 806 a nearest prototype is selected based on the distances computed in block 804. In block 806, in case of a tie, one of the tied nearest prototype vectors is selected, e.g., randomly. In block 808 the identity of the winning prototype is output as a label for the feature vector received in block 802.

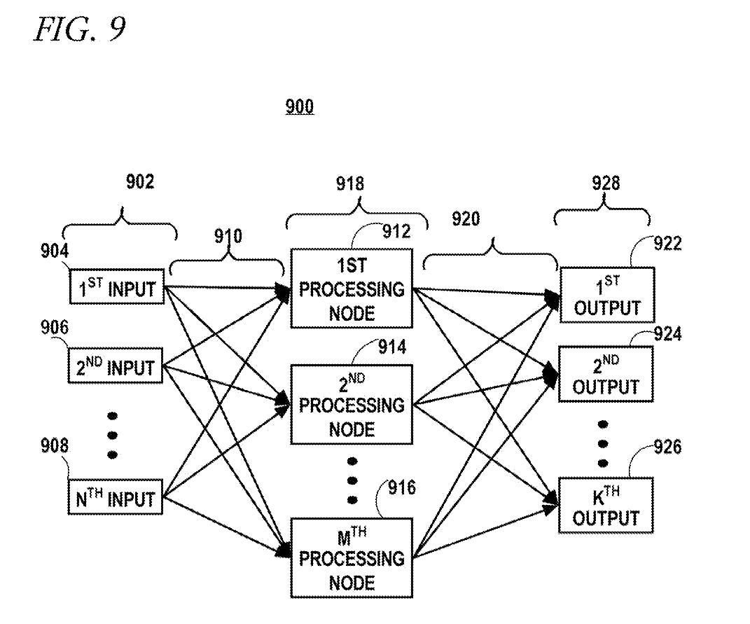

FIG. 9 is a schematic representation of a Q-metric based Artificial Neural Network (ANN) 900 according to an embodiment of the invention. The Q-metric based ANN 900 is one example of a type of vector-subspace assignor that may be used in the pattern recognition system 100. The Q-metric based ANN 900 comprises an input layer 902 including a first input node 904, a second input node 906 and an N^{TH} input node 908. Each input node 904, 906, 908 can, for example, receive an element of a feature vector. The three inputs 904, 906, 908 are coupled by a first set of weighted couplings 910 to a first processing node 912, a second processing node 914 and an M^{TH} processing node 916 in a hidden layer 918. The processing nodes 912, 914, 916 in the hidden layer 918 are coupled by a second set of weighted couplings 920 to a first output node 922, a second output node 924 and a K^{TH} output node 926 of an output layer 928. Note that although, as shown each input is connected to each processing node and each processing node is connected to each output node, alternatively certain couplings are eliminated. Although three input nodes, three processing nodes and three output nodes are shown for purposes of illustration, in practice the number of nodes may be varied.

The output of each i^{th} processing node in the hidden layer 918 is determined by a subprogram or hardware, the operation of which can be described by the following recasting of the weighed Q-metric formula:

$${y}_{i} = \{ \begin{matrix}\frac{{\prod }_{j = 1}^{n} ( 1 + {λ}_{i} {w}_{j} \vert {x}_{j} - {c}_{ij} \vert ) - 1}{λ} & {λ}_{i} ∈ [ - 1 , 0 ) \\ {\sum }_{j = 1}^{n} {w}_{j} \vert {x}_{j} - {c}_{ij} \vert & {λ}_{i} = 0\end{matrix} : \qquad EQU . 5$$

where, yᵢ ∈ [0,n] is the output of the i^{th} processing node;

λᵢ ∈ [−1,0] is a configuration parameter used by the i^{th} processing node;

xᵢ ∈ [0,1] is an i^{th} component of a first n-dimensional input feature vector denoted x;

wᵢⱼ ∈ [0,1] is weight defining a coupling between a j^{th} input and the i^{th} processing node; and

cᵢⱼ ∈ [0,1] is a j^{th} coordinate of an i^{th} feature vector space center (cluster center) that is associated with the i^{th} processing node.

### Note that the weights wᵢⱼ are suitably chosen from the range zero to one.

Similarly, the output of each output node of the Q-metric based ANN 900 can be described by the following recasting of the weighed Q-metric formula:

$${z}_{i} = \{ \begin{matrix}\frac{{\prod }_{j = 1}^{n} ( 1 + {λ}_{i} {v}_{ij} \vert {x}_{j} - {d}_{ij} \vert ) - 1}{λ} & {λ}_{i} ∈ [ - 1 , 0 ) \\ {\sum }_{j = 1}^{n} {v}_{ij} \vert {x}_{j} - {d}_{ij} \vert & {λ}_{i} = 0\end{matrix} \qquad EQU . 6$$

where, zᵢ ∈ [0,n] is the output of the i^{th} output node;

λᵢ ∈ =[−1,0] is a configuration parameter used by the i^{th} output node;

vᵢⱼ ∈ =[0,1] is weight defining a coupling between a j^{th} processing node and the i^{th} output; and

dᵢⱼ is a j^{th} coordinate of an i^{th} feature vector space center that is associated with the i^{th} output.

The Q-metric based ANN 900 can be trained to identify a particular classification by making an output assigned to the particular classification have the lowest value among all the outputs when a feature vector belonging to the classification is input. In this case the output part of the training data may include a zero for the output corresponding to the correct classification and ones for the other outputs.

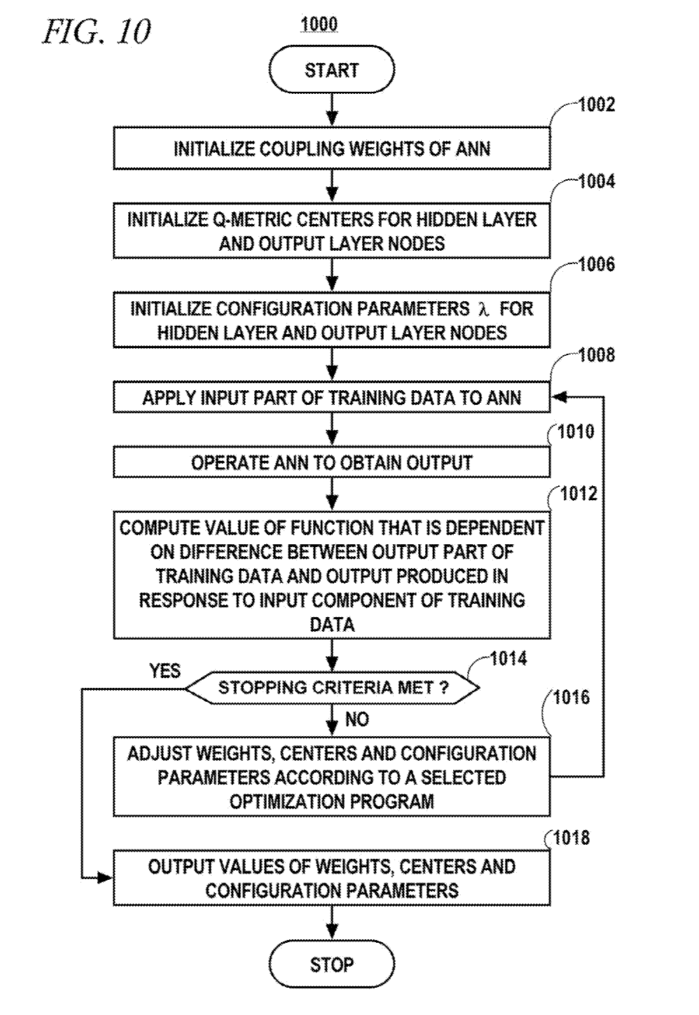

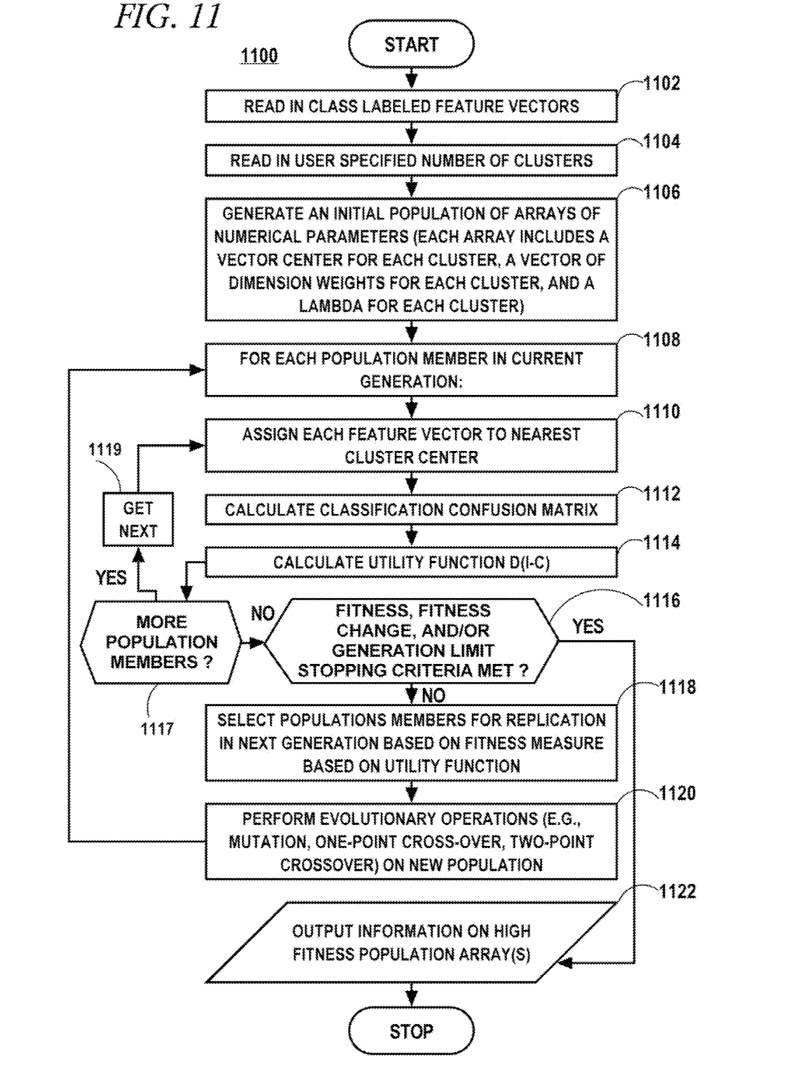

FIG. 10 is a flowchart 1000 of a program for training a Q-metric based ANN pattern recognition program. In block 1002 a set of coupling weights of the Q-metric based ANN 900 are initialized, in block 1004 centers associated with the hidden layer nodes 912, 914, 916 and outputs 922, 924, 926 are initialized and in block 1006 the configuration parameters λᵢ, λᵢ for the processing nodes 912, 914, 916 and outputs 922, 924, 926 are initialized. The parameters initialized in blocks 1002-1006 can be initialized randomly or to predetermined values. In block 1008 input parts of training data is input into the Q-metric based ANN 900. The training data suitably includes input values for each of the inputs 904, 906, 908 of the Q-metric based ANN 900 and associated output values for each of the outputs 922, 924, 926. The training data suitably includes many exemplars which represent the variation of input that the Q-metric based ANN 900 is expected to process in actual on-line use. In block 1010 the Q-metric based ANN is operated in order to obtain output values. In block 1012 the value of an objective function is computed. The objective function depends on the difference between the actual output of the Q-metric based ANN produced in response to training exemplars and correct class labels included in the training data. The objective function suitably aggregates the difference computed using all of the training exemplars. The objective function may be the sum of the differences, the sum of the squares of the differences, for example. Alternatively, the objective function may combine the differences using the Q-metric itself by treating each difference as a separate dimension.

Block 1014 is a decision block the outcome of which depends on whether one or more stopping criteria has been met. The stopping criteria may include a lower limits on iteration-to-iteration changes of the parameters being optimized, i.e., vᵢⱼ, wᵢⱼ, cᵢⱼ, dᵢⱼ, λᵢ, λᵢ, a lower limit on iteration-to-iteration change in the objective function value or an upper limit on a number of optimization iterations. (Each run through the program loop including blocks 1008-1016 is considered one iteration.) Note that the iteration-to-iteration difference in the parameters being optimized may be a vector difference such as a Euclidean difference or the Q-metric distance. If the stopping criteria has not been met, then in block 1016 the coupling weights, centers and configuration parameters are adjusted according to an optimization subprogram and the program 1000 loops back to block 1008 in order to run through another iteration. The optimization methods discussed above or others may be used in block 1016. When the stopping criteria is met the program 1000 branches to block 1018 in which values of the coupling weights, centers and configuration parameters found by the training program 1000 are output.

FIG. 11 is a flowchart of a program 1100 for training supervised training of a nearest prototype pattern recognition system. The program 1100 uses a genetic algorithm/Differential Evolution numerical optimization strategy to find cluster centers which are identified as prototype vectors. Once the program 1100 has finished the prototype vectors, along with a lambda, and a set of dimension weights for each cluster are output for use in pattern recognition.

In block 1102 a set of class labeled feature vectors, i.e., a training data set, is read in. The feature vectors, may be obtained from a feature vector subsystem from a variety of types of pattern recognitions systems, including but not limited to fingerprint recognition, handwriting recognition, speech recognition, or face recognition for example.

In block 1104 a user specified number of clusters is read. The number can be based on some foreknowledge such as developed by examining distributions of feature vectors. The number of clusters is at least equal to the number of classes.

In block 1106 an initial population of arrays of numerical parameters is generated. Each array includes a value of lambda for each cluster, a set of dimension weights for each cluster, and a center for each cluster. (Alternatively, a common set of dimension weights is shared by all clusters. In this alternative the relative value of each feature in the feature vectors for the purpose of classification is determined by the program 1100.) The number of dimension weights is equal to the dimensionality of the feature vectors. The center is vector in the feature vector space. The initial values may be selected randomly within bounds. The bounds for lambda are minus one to zero and the bounds for each element of the center and the dimension weights are zero to one.

Block 1108 is the top of a loop (including blocks 1108, 1110, 1112, 1114, 1116, 1117, 1119) that processes each array of numerical parameters in the population in turn. For the discussion below each array population member is processed by the loop is called the k^{TH} population member. One skilled in the art will appreciate that this loop may be parallelized, on a parallel computer or computer cluster. In block 1110 each feature vector in the training data is assigned to a cluster center (k^{TH} population member) that it is closest to the feature vector as measured by the weighted Q-metric using the weights and values of lambda for the cluster stored in the k^{TH} population member. Although not shown in detail block 1110 would typically comprise an inner loop that runs through successive feature vectors in the training data set.

When block 1110 is finished each feature vector will have been assigned to a cluster center of the k^{TH} population member. In block 1112 a normalized confusion matrix is calculated. First an un-normalized cluster-class matrix is tabulated. The un-normalized cluster-class matrix can be represented as:

$${CC}_{U} = [ \begin{matrix}{n}_{11} & … & {n}_{1 k} \\ … & … & … \\ {n}_{j 1} & … & {n}_{jk}\end{matrix} ] \qquad EQU . 7$$

Each column of the un-normalized cluster-class matrix corresponds to one of the classes of the class labeled feature vectors in the training data, and each row corresponds to one of the clusters. The un-normalized cluster-class matrix is normalized by dividing each element by the two norm of the column in which the element appears. Thus the confusion matrix is given by:

$$\begin{matrix}CC = [ \begin{matrix}{n}_{11} / {N}_{1} & … & {n}_{1 k} / {N}_{k} \\ … & … & … \\ {n}_{j 1} / {N}_{1} & … & {n}_{jk} / {N}_{k}\end{matrix} ] where , & EQU . 8 \\ {N}_{k} = \sqrt{{\sum }_{t = 1}^{j} {n}_{tk}^{2}} & EQU . 9\end{matrix}$$

After the normalization, each column of matrix cluster-class matrix becomes the distribution of a class on all clusters, i.e.,

CC={n₁ . . . nₖ} EQU. 10

It is apparent that, 0≦nᵢ·nⱼ≦1 and nᵢ·nᵢ=1 for nᵢ≠0. If every cluster only contains one class, we will havens nᵢ·nⱼ=0 for i≠j. Using these results, we can have classification confusion matrix as:

$$C = {CC}^{T} \cdot CC = [ \begin{matrix}1 & … & {n}_{1} \cdot {n}_{k} \\ … & … & … \\ {n}_{k} \cdot {n}_{1} & … & 1\end{matrix} ] \qquad EQU . 11$$

For a perfect classification, the above confusion matrix becomes an identity matrix. Thus, to optimize the classification from clustering is to minimize the distance between the confusion matrix and its identity matrix, i.e., min d(I−C). The distance between the identity matrix and the classification confusion matrix can be defined as:

$${‖ I - C ‖}^{2} = {\sum }_{i} {\sum }_{j} {( {I}_{ij} - {C}_{ij} )}^{2} \qquad EQU . 12$$

In block 1114 the utility function (otherwise known as the objective function) which is the distance between the confusion matrix and the identity matrix is calculated.

The utility function is a measure of fitness of the k^{TH} population member which will be used in optimizing the population in order to find the best set of clusters centers, dimension weights, and λ's for use in nearest prototype pattern recognition.

Next decision block 1117 tests if there are more population members to be tested. If so, then in block 1119 a next population member is accessed and the program 1110 loops back to block 1110 in order to process the next population member as previously described. When it is determined in block 1117 that all population members have been processed, then the program 1100 branches to decision block 1116.

Decision block 1116 tests if a stopping criteria for the program 1110 has been met. The stopping criteria may be based on a best measure of fitness (lowest distance between the confusion matrix and its identity matrix) achieved in the latest generation of the population, an average fitness, a generation limit, a generation to generation change in the fitness or a combination of one or more of the foregoing. In each case one or more numerical comparisons may be performed to determine if the fitness criteria has been satisfied. For example, for a stopping criteria based on the best measure of fitness the lowest distance between the confusion matrix and its identity matrix achieved in the latest generation can be compared to a preprogrammed small distance value.

If it is determined in block 1116 that the stopping criteria has been met, then in block 1112 information on one or more high fitness population members is output, e.g., on a computer display. Additionally, the information may be output to a file for future examination by the user. The information that is output suitably includes at least the entire highest fitness array, and may include the fitness metrics and other diagnostic information such as for example the final generation number.

If it is determined in block 1116 that the fitness criteria has not been satisfied then the program branches to block 1118. In block 1118 the next generation of arrays of numerical parameters (λ's, dimension weights, cluster centers) is selected from the current generation based, at least in part, on fitness. According to the certain embodiments, population members are selected for replication using a stochastic remainder method. In the stochastic remainder method at least a certain number Iᵢ of copies of each population member are replicated in a successive generation. The number Iᵢ is given by the following equation:

$${I}_{i} = Trunc ( N * \frac{{PF}_{i}}{{\sum }_{i = 1}^{N} {PF}_{i}} ) : \qquad EQU . 13$$

where, N is the number of population members in each generation (typically a constant);
PFᵢ is the fitness of the i^{th} population member determined in block 1114; and
Trunc is the truncation function.

The fractional part of the quantity within the truncation function in equation thirteen is used to determine if any additional copies of each population member (beyond the number of copies determined by equation three) will be replicated in the successive generation. The aforementioned fractional part is used as follows. A random number between zero and one is generated. If the aforementioned fractional part exceeds the random number then an addition copy the i^{th} population member is added to the successive generation. The number of selections made using random numbers and the fractional parts of numbers Iᵢ is adjusted so that successive populations maintain a programmed total number N of sets of numerical parameters.

Using the above described stochastic remainder method leads to selection of population members for replication based largely on fitness, yet with a degree of randomness. The latter selection method mimics natural selection in biological systems.

Next in block 1120 evolutionary operations are performed on the population selected in block 1118. The evolutionary operations suitably include one-point cross over, two-point crossover, genetic algorithm (G.A.) mutation, and Differential Evolution (D.E.) mutation. In performing crossover operations population members are paired together (e.g., randomly). A single crossover probability or separate crossover probabilities may be used in deciding whether or not to perform one and two-point crossover operations. For each type of crossover operation, and for each pair of population members a random number between zero and one is generated. If the random number is less than the crossover probability, then a crossover operation is performed, if the random number is greater than the crossover operation then the pair of population members is kept unchanged. Alternative methods for determining whether crossover operations are performed may be used. If it is determined that a one point crossover operation is to be performed between a pair of population members then a crossover point is selected at random. Thereafter, all the elements (numerical values) in the two population members that follow the crossover point are exchanged between the two arrays of numerical values. If it is determined that a two-point crossover operation is to be performed between two population members, then two points are selected at random and elements of the population members between the two points are exchanged.

One form of G.A. mutation is expressed by the following formula:

xᵢ^{new}=xᵢ+(rand−0.5)(0.1xᵢ+eps) EQU. 14

where, xᵢ is a numerical value being mutated
xᵢ^{new} is a mutated numerical value;

eps is a machine constant equal to the smallest number that can be represented in the floating point system of the machine Note that equation four illustrates a mutation limited to a maximum of plus or minus 5%. 5% is a reasonable limit for mutation but may be changed if desired.

D.E. mutation operates on an entire population member which is an array of numerical values. One form of D.E. mutation is expressed by the following formula:

Xᵢ^{new}=X_{best}+f·(Xⱼ+Xₖ−Xₗ−Xₘ) EQU. 15

where, Xᵢ^{new} is a new population member that replaces population member Xᵢ that has been selected for D.E. mutation;
X_{best} is the population member that yielded the highest fitness;
Xⱼ, Xₖ, Xᵢ, Xₘ, are other population members (e.g., other population members selected at random; and

f is a scalar factor that is suitably set to a value in the range of between 0.1 to two.

Every individual numerical value in the replicated population is considered a candidate for applying GA mutation and every population member (array of numerical values) is considered a candidate for D.E. mutation. In order to determine whether GA mutation and DE mutation is applied to each numerical value and set of numerical values respectively, a random number between zero and one can be generated for each entity and compared to preprogrammed GA and DE mutation probabilities. If the random number is less than the preprogrammed GA or DE mutation probabilities then the entity (i.e. numerical value or array of numerical values respectively) is mutated. Alternatively other evolutionary operations may be performed.

After block 1120, the program 1100 loops back to block 1108 and continues executing with the new population, as described above. One use of the program 1100 is to train a Q-metric based nearest prototype feature vector sub-space assignor. Another application is to train the hidden layers and output layer of a Q-metric based ANN of the type shown in FIG. 9.

Alternatively, rather than using genetic algorithm/Differential Evolution numerical optimization as described above with reference to FIG. 11, a different numerical optimization such as for example the Nelder-Mead algorithm, or the Simulated Annealing Algorithm can be used.

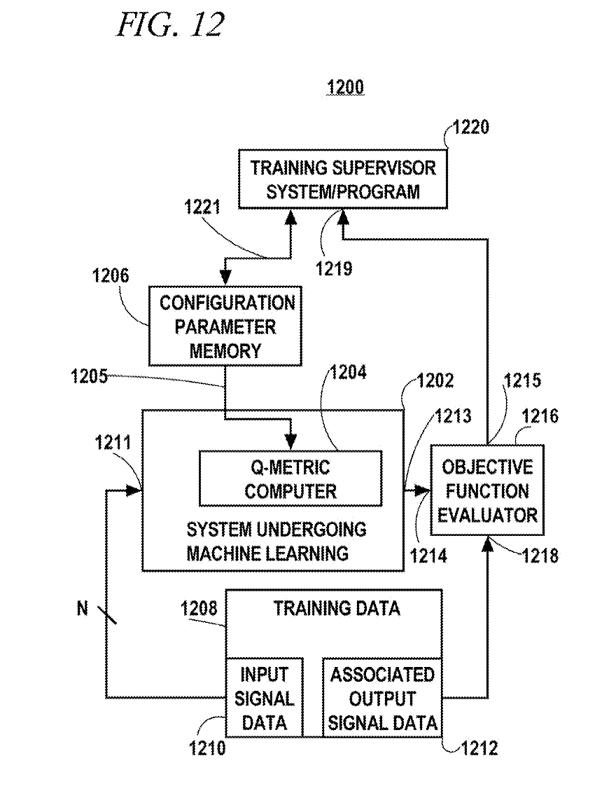

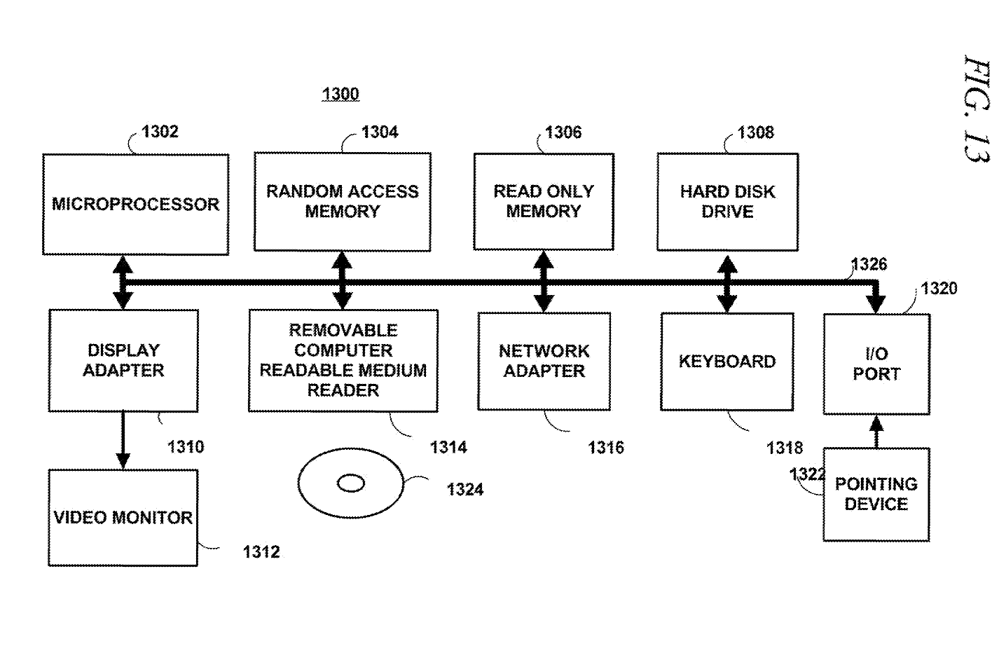

FIG. 12 is a high level block diagram of a machine learning system 1200 that uses one or more of the Q-metric evaluators. The machine learning system 1200 includes a processing system 1202 that can be trained in the machine learning system 1200. The processing system 1202 can be, for example, a pattern recognition system, or some other type of signal processing system. The processing system 1202 includes a Q-metric computer 1204 of the type described above. The Q-metric computer 1204 is used to compute the distance between feature vectors and/or prototype vectors at intermediate stages within the processing system 1202. The configuration parameter(s) λ for the Q-metric computer 1204, which are stored in a configuration parameter memory 1206, are not fixed. The configuration parameter memory 1206 is coupled to a configuration parameter input 1205 of the Q-metric computer 1204. The configuration parameter(s) λ are set in the course of machine learning. The machine learning system 1200 also includes a training data memory 1208. The training data memory 1208 and the control parameter memory 1206 can be implemented in a single physical memory or in physically separate memories. The training data memory 1208 stores training data that includes input signal data 1210 and associated output signal data 1212. The input signal data 1210 includes data for each of N inputs of the processing system 1202. The number of inputs is typically related to a number of sensors, or the resolution of sensors with which the processing system 1202 is to be used after the processing system 1202 has been trained in the machine learning system 1200. The training data memory 1208 suitably stores many sets of training data spread over an entire range of values of inputs that the processing system 1202 is expected to encounter in actual use. The input signal data 1210 is fed into an input 1211 of the processing system 1202 which processes the input signal data 1210 to produce an output 1213 of the processing system 1202. The output 1213 of the processing system 1202 is input into a first input 1214 of an objective function evaluator 1216. The associated output signal data 1212 component of the training data is input into a second input 1218 of the objective function evaluator 1216. The objective function evaluator 1216 suitably evaluates a function that depends on the difference between the associated output signal data 1212 component of the training data 1208 and the output 1213 of the processing system 1202 that is produced in response to the input signal data 1210. An output 1215 of the objective function evaluator 1216 is coupled to an input 1219 of a training supervisor 1220. The training supervisor 1220 is coupled to the configuration parameter memory 1206 through a read/write coupling 1221, allowing the training supervisor 1220 to read and update the configuration parameter(s) λ. The training supervisor 1220 suitably implements an optimization strategy such as, a direct search method, e.g., the simplex method, simulated annealing, Differential Evolution or a method that uses derivative information, e.g., the conjugate gradient method. The training supervisor system 1220 adjusts one or more of the configuration parameters λ stored in the configuration parameter memory 1206 according to the optimization strategy until a stopping criteria is met. In embodiments in which there are multiple configuration parameters λ for multiple classifications, the training supervisor system adjusts the configuration parameters for each classification, separately so as to shape the decision boundary between classifications in a manner that reduces erroneous classifications. The goal of optimization is to reduce the difference between the output of the processing system 1202 and the associated output signal data 1212 component of the training data 1208. Thus, the stopping criteria can be based, at least in part, on the aforementioned difference. When the stopping criteria is met, a set of final values of the variable configuration parameters λ are suitably stored for future use by the processing system 1202. The system 1200 is most readily implemented in software. However, for mass production it may be more economical to duplicate the processing system 1202 in hardware after the control parameters have been determined using the machine learning system 1200.

Using the configurable Q-metric computer 1204, allows the machine learning system to make qualitative changes in the manner in which signals are processed in the processing system 1202 by making adjustments to the configuration parameters λ.

Alternatively, in lieu of using the Q-metric machine the learning system 1200 can use a different configurable metric.

FIG. 13 is a block diagram of a computer 1300 that can be used to execute the programs described above according to embodiments of the invention. The computer 1300 comprises a microprocessor 1302, Random Access Memory (RAM) 1304, Read Only Memory (ROM) 1306, hard disk drive 1308, display adapter 1310, e.g., a video card, a removable computer readable medium reader 1314, a network adaptor 1316, keyboard 1318, and I/O port 1320 communicatively coupled through a digital signal bus 1326. A video monitor 1312 is electrically coupled to the display adapter 1310 for receiving a video signal. A pointing device 1322, preferably a mouse, is coupled to the I/O port 1320 for receiving signals generated by user operation of the pointing device 1322. The network adapter 1316 can be used, to communicatively couple the computer to an external source of data, e.g., a remote server. The computer readable medium reader 1314 preferably comprises a Compact Disk (CD) drive. A computer readable medium 1324, that includes software embodying the programs described above is provided. The software included on the computer readable medium 1324 is loaded through the removable computer readable medium reader 1314 in order to configure the computer 1300 to carry out programs of the current invention that are described above with reference to the FIGS. The computer 1300 may for example comprise a personal computer or a work station computer. Computer readable media used to store software embodying the programs described above can take on various forms including, but not limited to, magnetic media, optical media, and semiconductor memory.

### Proof that Q-Metric Satisfies Metric Axioms

Metric Axioms: A function d(x, y) defined for x and y in a set X is a metric if:

d(x, y)≧0, and d(x, y)=0 if and only if x=y (1.1a)

d(x, y)=d(y, x) (1.1b)

d(x, y)+d(y, z)≧d(x, z) (1.1c)

Q-Metrics formulation is defined by:

$${d}_{λ} ( x , y ) = \{ \begin{matrix}\frac{{\prod }_{i = 1}^{n} ( 1 + λ \vert {x}_{i} - {y}_{i} \vert ) - 1}{λ} , & 0 > λ \geq 1 \\ {\sum }_{i = 1}^{n} \vert {x}_{i} - {y}_{i} \vert , & λ = 0\end{matrix} \qquad ( 1.2 )$$

where xᵢ, yᵢ ∈ [0,1], ∀i

Q-Metrics formula, EQ. 1.2, can be calculated recursively:

d₀=0

dᵢ=dᵢ₋₁+|xᵢ−yᵢ|+λdᵢ₋₁|xᵢ−yᵢ|=dᵢ₋₁+|xᵢ−yᵢ|·(1+λdᵢ₋₁)

. . .

d_{λ}=dₙ (1.3)

From EQ. 1.2, we can simply express Q-Metrics for λ=0 as:

$${d}_{λ} = {\sum }_{i = 1}^{n} \vert {x}_{i} - {y}_{i} \vert \qquad ( 1.4 )$$

### Now, we prove that Q-Metrics (EQ. 1.2, 1.3, and 1.4) satisfies the Metric Axioms.

First, for λ=0, EQ. 1.4, we have,

$$\begin{matrix}{d}_{λ} = {\sum }_{i = 1}^{n} \vert {x}_{i} - {y}_{i} \vert \geq 0 , and {d}_{λ} = 0 if and only if x = y ; & ( 1.5 a ) \\ {d}_{λ} ( x , y ) = {\sum }_{i = 1}^{n} \vert {x}_{i} - {y}_{i} \vert = {\sum }_{i = 1}^{n} \vert {y}_{i} - {x}_{i} \vert = {d}_{λ} ( y , x ) ; \\ Since \vert {x}_{i} - {y}_{i} \vert + \vert {y}_{i} - {z}_{i} \vert \geq \vert {z}_{i} - {x}_{i} \vert for all i , we also have & ( 1.5 b ) \\ \begin{matrix}{d}_{λ} ( x , y ) + {d}_{λ} ( y , z ) = {\sum }_{i = 1}^{n} \vert {x}_{i} - {y}_{i} \vert + {\sum }_{i = 1}^{n} \vert {y}_{i} - {z}_{i} \vert \geq {\sum }_{i = 1}^{n} \vert {x}_{i} - {z}_{i} \vert \\ = {d}_{λ} ( x , z )\end{matrix} & ( 1.5 c )\end{matrix}$$

### Thus, for the situation λ=0, Q-Metrics formulation satisfies the Metric Axioms.

Second, for −1≦λ<0, rewrite EQ. 1.3 as

d_{λ}=dₙ=dₙ₋₁+|xₙ−yₙ|+λdₙ₋₁|xₙ−yₙ|=dₙ₋₁·(1+λ|xₙ−yₙ|)+|xₙ−yₙ| (1.6)

Since |xₙ−yₙ|≦1 for xᵢ,yᵢ ∈ [0,1], we have 1+λ|xₙ−yₙ|≧0 for λ≧−1. Then, it is obvious that EQ. 1.6 satisfies the Metrics Axiom (1.1a) and (1.1b).

From EQ. 1.2, dₙ(x,y), is monotonic increasing with any |xₖ−yₖ|, because,

$$\frac{\partial {d}_{n} ( x , y )}{\partial \vert {x}_{k} - {y}_{k} \vert} = {\prod }_{i = 1 , i \neq k}^{n} ( 1 + λ \vert {x}_{i} - {y}_{i} \vert ) \geq 0 \qquad ( 1.7 )$$

### From EQ. 1.4, dₙ(x,y), is also monotonic increasing with dₙ₋₁(x,y), because,

$$\frac{\partial {d}_{n} ( x , y )}{\partial {d}_{n - 1} ( x , y )} = 1 + λ \vert {x}_{n} - {y}_{n} \vert \geq 0 \qquad ( 1.8 )$$

### With EQ. 1.7 and 1.8, we are going to prove that for −1≦λ<0, Q-Metrics satisfies the Metrics Axiom (1.1c) by induction on the index i.

Using EQ. 1.3, we have,

d₁(x,z)=|x₁−z₁|≦|x₁−y₁|+|y₁−z₁|=d₁(x,y)+d₁(y,z) (1.8)

Thus, let's assume

dᵢ₋₁(x,z)≦dᵢ₋₁(x,y)+dᵢ₋₁(y,z) (1.10)

From EQ. 1.3,

dᵢ(x,z)=dᵢ₋₁(x,z)+|xᵢ−zᵢ|+λdᵢ₋₁(x,z)·|xᵢ−zᵢ| (1.11)

Since |xᵢ−yᵢ|+|yᵢ−zᵢ|≧|zᵢ−xᵢ|, and from EQ. 1.7, dᵢ(x,z) monotonically increases with |xᵢ−zᵢ| part increasing, so that,

dᵢ(x,z)≦dᵢ₋₁(x,z)+(|xᵢ−yᵢ|+|yᵢ−zᵢ|)+λdᵢ₋₁(x,z)·(|xᵢ−yᵢ|+|yᵢ−zᵢ|) (1.12)

From EQ. 1.8, dᵢ(x,z) monotonically increases with dᵢ₋₁(x,z) part increase.

So that by using EQ. 1.11, EQ. 1.12 becomes,

$${d}_{i} ( x , z ) \leq ( {d}_{i - 1} ( x , y ) + {d}_{i - 1} ( y , z ) ) + ( \vert {x}_{i} - {y}_{i} \vert + \vert {y}_{i} - {z}_{i} \vert ) + λ ( {d}_{i - 1} ( x , y ) + {d}_{i - 1} ( y , z ) ) \cdot ( \vert {x}_{i} - {y}_{i} \vert + \vert {y}_{i} - {z}_{i} \vert ) \qquad ( 1.13 )$$

### Thus, form EQ. 1.13, we have

$${d}_{i} ( x , z ) \leq {d}_{i - 1} ( x , y ) + \vert {x}_{i} - {y}_{i} \vert + λ {d}_{i - 1} ( x , y ) \cdot \vert {x}_{i} - {y}_{i} \vert + {d}_{i - 1} ( y , z ) + \vert {y}_{i} - {z}_{i} \vert + λ {d}_{i - 1} ( y , z ) \cdot \vert {y}_{i} - {z}_{i} \vert + λ \cdot ( {d}_{i - 1} ( x , y ) \cdot \vert {y}_{i} - {z}_{i} \vert + {d}_{i - 1} ( y , z ) \cdot \vert {x}_{i} - {y}_{i} \vert ) = {d}_{i} ( x , y ) + {d}_{i} ( y , z ) + λ \cdot ( {d}_{i - 1} ( x , y ) \cdot \vert {y}_{i} - {z}_{i} \vert + {d}_{i - 1} ( y , z ) \cdot \vert {x}_{i} - {y}_{i} \vert ) \leq {d}_{i} ( x , y ) + {d}_{i} ( y , z )$$

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A pattern recognition system comprising:
a configurable feature vector metric computer adapted to:
receive a configuration parameter according to which said configurable feature vector metric computer is configured;
receive a plurality of feature vectors representing measured subjects;
compute one or more distances between said feature vectors using the configurable feature vector metric; and
to output said one or more computed distances.

2. The pattern recognition system according to claim 1 wherein:
for values of said configuration parameter in a domain [−1,0), operation of said configurable feature vector metric computer to compute said one or more computed distances from said plurality of feature vectors is described by an equation:
$${d}_{λ , n} ( x , y ) = [ {\prod }_{i = 1}^{n} ( 1 + λ \vert {x}_{i} - {y}_{i} \vert ) - 1 ] / λ$$
where λ is said configuration parameter;
xᵢ ∈ [0,1] is an i^{th} component of a first n-dimensional feature vector denoted x
yᵢ ∈ [0,1] is an i^{th} component of a second n-dimensional feature vector denoted y
d_{λ}(x,y) ∈ [0,n] is a computed distance between the first feature vector and the second feature vector.

3. The pattern recognition system according to claim 2 wherein:
said configurable feature vector metric computer is adapted to compute said one or more computed distances from said plurality of feature vectors by evaluating a recursive function:
ψᵢ=|xᵢ−yᵢ|+ψᵢ₋₁+λ|xᵢ−yᵢ|ψᵢ₋₁, i=1, . . . , n;
starting with:
ψ₀=0

4. The pattern recognition system according to claim 1 comprising:
a neural network pattern recognition system including a plurality of nodes, each of which operates on one or more inputs and produces an output, and wherein one or more of said plurality of nodes is adapted to use said configurable feature vector metric computer to compute said output from said one or more inputs.

5. The pattern recognition system according to claim 4 wherein:
each i^{th} node is adapted to operate on input in order to produce an output by a process that is described by an equation:
$${y}_{i} = \{ \begin{matrix}\frac{{\prod }_{j = 1}^{n} ( 1 + {λ}_{i} {w}_{j} \vert {x}_{j} - {c}_{ij} \vert ) - 1}{λ} & {λ}_{i} ∈ [ - 1 , 0 ) \\ {\sum }_{j = 1}^{n} {w}_{j} \vert {x}_{j} - {c}_{ij} \vert & {λ}_{i} = 0\end{matrix}$$
where, λᵢ ∈ [−1,0] is a configuration parameter used by the i^{th} node;
yᵢ ∈ [0,n] is the output of the i^{th} node;
wᵢⱼ ∈ [0,1] is weight defining a coupling between a j^{th} node in a layer preceding the i^{th} node and the i^{th} node;
xᵢ ∈ [0,1] is an i^{th} component of an n-dimensional input feature vector denoted x; and
cᵢⱼ ∈ [0,1] is a j^{th} coordinate of an i^{th} feature vector space center that is associated with the i^{th} node.

6. The pattern recognition system according to claim 1 comprising:
a nearest prototype program executing computer wherein said nearest prototype program computes said one or more computed distances between input feature vectors and prototype feature vectors using said configurable feature vector metric computer.

7. A machine learning system comprising the:
the pattern recognition system according to claim 1;
a training supervisor system adapted to optimize said configuration parameter in order to reduce recognition errors.

8. The machine learning system according to claim 7 wherein said training supervisor system is adapted to optimize said configuration parameter separately for each of a plurality of classifications that are recognizable by said pattern recognition system.

9. The pattern recognition system according to claim 1 wherein said configurable feature vector metric computer comprises:
a subtracter comprising:
a first input for receiving a first feature vector;
a second input for receiving a second feature vector; and
an output;
wherein, said subtracter is adapted to compute a vector difference between said first feature vector and said second feature vector;
a magnitude computer comprising:
an input coupled to said output of said subtracter; and
an output;
wherein, said magnitude computer is adapted to compute an absolute value of each element of said vector difference;
at least one memory for storing said configuration parameter;
a first multiplier coupled to said at least one memory, said first multiplier comprising:
a first input for receiving said configuration parameter;
a second input for sequentially receiving a sequence of quantities each including one of said absolute value of said element of said vector difference; and
an output for outputting a product of said configuration parameter and each absolute value of said element of said vector difference;
a second multiplier comprising:
a first input coupled to said output of said first multiplier;
a second input; and
an output;
a first adder comprising:
a first input coupled to said output of said second multiplier;
a second input coupled to said at least one memory, for sequentially receiving said absolute value of each element of said vector difference; and
an output;
a second adder comprising:
a first input coupled to said output of said first adder;
a second input; and
an output for outputting a function value, which after a number of cycles of operations of the configurable feature vector metric computer equal to a dimension of the said first feature vector and said second feature vector is equal to said configurable feature metric;
a shift register comprising:
an input coupled to said output of said second adder; and
an output coupled to said second input of said second multiplier and coupled to said second input of said second adder.

10. The pattern recognition system according to claim 1 comprising an unsupervised classification system comprising a computer configured by at least one program to:
until a closest cluster center for each of a set of feature vectors, as measured by said configurable feature vector metric computer stabilizes:
find a closest cluster center among a set of cluster centers for each of said set of feature vectors;
optimize cluster center coordinates of said set of cluster centers and the configuration parameter for each cluster center of said set of cluster centers, in order to minimize a sum of distances from each particular cluster center to feature vectors that are closest to the particular cluster center.

11. The pattern recognition system according to claim 10 wherein:
for values of said configuration parameter in a domain [−1,0), operation of said configurable feature vector metric computer to compute said one or more computed distances from said plurality of feature vectors is modeled by an equation:
$${d}_{λ , n} ( x , y ) = [ {\prod }_{j = 1}^{n} ( 1 + λ \vert {x}_{i} - {y}_{i} \vert ) - 1 ] / λ$$
where λ is said configuration parameter;
xᵢ ∈ [0,1] is an i^{th} component of a first n-dimensional feature vector denoted x
yᵢ ∈ [0,1]is an i^{th} component of a second n-dimensional feature vector denoted y
d_{λ}(x,y)∈ [0,n] is a computed distance between the first feature vector and the second feature vector.

12. The pattern recognition system according to claim 1 comprising a supervised nearest prototype pattern recognition training system comprising a computer configured by at least one program to:
read a set of class labeled training feature vectors;
read a specified number of clusters;
numerically optimizing, at least, a set of clusters centers for said specified number of clusters, and a set of values of said configuration parameter for said specified number of clusters in order to minimize sharing of nearest cluster centers by class labeled training vectors of different classes.

13. The pattern recognition system according to claim 12, wherein in numerically optimizing, said computer is configured by said at least one program to:
generate an initial population of arrays of numerical parameters, wherein each array includes a cluster center for each of the specified number of clusters, and a value of said configuration parameter for each of the specified number of clusters;
for each of a succession of generations of said population of arrays; and
for each array:
assign each class labeled training feature vector to a said cluster center that is nearest to each class labeled training feature vector;
calculate a classification confusion matrix; and
calculate a fitness measure from said classification confusion matrix;
check if a stopping criteria has been met, and if said stopping criteria has not been met:
replicating arrays for a next generation based on said fitness measure;
perform evolutionary operations on said next generation.

14. The pattern recognition system according to claim 13 wherein each array also includes at least one set of dimension weights.

15. The pattern recognition system according to claim 14 wherein each array includes a set of dimension weights for each of the specified number of clusters.

16. The pattern recognition system according to claim 13, wherein in calculate said fitness measure, said computer is configured by said at least one program to:
multiply the classification confusion matrix by a transpose of the classification confusion matrix to obtain a confusion matrix;
subtract the confusion matrix from an identity matrix to obtain a difference matrix; and
sum squares of elements of the difference matrix.
